(19) United States
(12) Patent Application Publication
(10) Pub. No.: US 2017/0241115 A1
(43) Pub. Date: Aug. 24, 2017

(54) VALVE INSERT

(71) Applicant: McAlpine & Co. Ltd., Glasgow, Strathclyde (GB)

(72) Inventor: James Edward McAlpine, Paisley (GB)

(21) Appl. No.: 15/512,804

(22) PCT Filed: Sep. 24, 2015
(86) PCT No.: PCT/GB2015/052768

§ 371 Date: Mar. 20, 2017

(30) Foreign Application Priority Data
Sep. 26, 2014 (GB) 1417013.8

(51) Int. Cl. E03C 1/298; E03C 1/22; F16K 15/16

(52) U.S. Cl. CPC E03C 1/298; F16K 15/16; E03C 1/22

(57) ABSTRACT

The present invention provides a one-way drain valve comprising a fitting and a duckbill valve, wherein the fitting comprises one or more formations that prevent inward folding of the duckbill membrane upon reverse flow conditions without constituting an obstruction to the normal drain flow where entrained solids could forth a plug and thus, prevent adequate drainage. The formations extend parallel to or ergent from a fitting longitudinal axis. The fitting may comprise a recess or other suitable feature adapted to facilitate engagement with the duckbill valve.

### FIELD OF THE INVENTION

The present invention relates to the technical field of plumbing, particularly, but not limited, to residential drainage fittings, although it can also find application in any kind of drainage conduction. The present invention is particularly suitable for easy connection of the drainage piping of a building and is especially suitable to prevent backflow, unpleasant odours in buildings and sewer creatures crawling up the drain pipes.

### BACKGROUND TO THE INVENTION

One way duckbill drain valves are commonly used nowadays for several purposes. Duckbill drain valves are useful for preventing backflow of drainage liquids, unpleasant odours migrating towards the interior of buildings and animals crawling up from the sewer system into buildings.

Duckbill valves comprise a flexible membrane in the shape of a duck beak, roughly speaking. The wider side of the membrane is located upstream and fitted onto an innervalve fitting perimeter and the narrower side is positioned downstream and remains loose or free.

In its undisturbed configuration, the free end of the membrane is closed, with its edges in contact with each other, so that practically there is no air circulation from the upstream side of the membrane to the downstream side and vice versa. When there is liquid flow, the weight of the liquid prompts the edges of the free end of the membrane to open and let the liquid and any entrained solid pass downstream.

When the pressure downstream of the valve is higher than upstream, the fluid tends to flow backwards. When this happens, the duckbill membrane, due to its special shape, presents a certain resistance to open its free end when the flow is reversed and in this way, the duckbill valve can work, at least to some extent, as a one-way valve.

However, if the pressure downstream of the valve is much higher than the pressure upstream of the valve, the duckbill membrane will reverse fully and open its free end and allow backflow. This is a known drawback of duckbill valves.

To solve this drawback, some manufacturers have devised to include inward protrusions, such as ribs, immediately upstream of the duckbill membrane, so that it cannot reverse upon backflow conditions. In this way, the backflow is prevented even when the pressure downstream of the valve is much higher that upstream. This solution is not ideal, because these protrusions can cause that some entrained solids in the drainage flow become stuck in them and can easily cause a plugged drain. Even if the drain is not plugged, the trapped solids, such as food waste or faeces can cause unpleasant odours upstream of the duckbill valve, which can easily migrate into the habitable spaces.

It is desired to solve or at least mitigate some of the disadvantages found in the prior art.

### SUMMARY OF THE INVENTION

According to a first aspect of the invention there is provided a one-way drain valve, the one-way drain valve comprising:

a fitting, the fitting comprising a body, the body defining a throughbore having a fitting longitudinal axis, the fitting further defining at least one formation, the/each formation having an internal surface, the/each internal surface defining a flat or a curved surface extending parallel to, or diverging from, the fitting longitudinal axis; and

a duckbill membrane,

wherein the duckbill membrane is attached to the fitting such that the/each formation extends into the duckbill membrane, in contact with a membrane sidewall, permitting substantially unrestricted flow through the duckbill membrane.

In at least one embodiment of the present invention, providing a one-way drain valve in which formations extend into a duckbill membrane, permits substantially unrestricted flow to be achieved through the one-way drain valve. This permits a greater flow area for liquids and any solids entrained in the liquids to pass through the one-way valve.

In at least one embodiment of the present invention, having the/each formation in contact with and supporting the duckbill membrane, prevents inward folding of the duckbill membrane thereby preventing backflow in a situation in which a negative pressure differential exists across the one-way drain valve. By a negative pressure differential it is meant that the upstream pressure is lower than the downstream pressure.

The fitting may comprise a plurality of formations.

The fitting may comprise two formations. In at least one embodiment of the present invention, a fitting with a plurality of formations is more effective at preventing inward folding of the duckbill membrane.

The/each fitting formations may extend into the duckbill membrane through a duckbill membrane inlet.

The/each formation may define one or more recesses. In at least one embodiment of the present invention, by providing one or more recesses in the/each formation it is possible to produce a fitting using less material.

The fitting may comprise a polymeric material.

The polymeric material may be plastic. In at least one embodiment of the present invention a fitting comprising polymeric or plastic material can be easily mass-produced and result in a more economical product.

The fitting may comprise a cylindrical body. In at least one embodiment of the present invention a fitting with a cylindrical body is more suitable to be installed into cylindrical drain piping.

The body may define an internal surface.

The body internal surface may be cylindrical.

The body internal surface may extend parallel to the fitting longitudinal axis.

The body internal surface may be equidistant from the fitting longitudinal axis as the/each formation internal surface.

In other embodiments, the body internal surface may be spaced away from the fitting longitudinal axis by a distance greater than or less than the/each formation internal surface.

The fitting body may have a diameter equal to the duckbill membrane inlet diameter.

The fitting body may comprise a recess to receive the duckbill membrane. In at least one embodiment of the present invention a fitting body with a recess to receive the duckbill membrane provides an easier way to assemble the fitting and the duckbill membrane together.

The fitting may be adapted to be inserted into the outlet of a sink, bath, shower or any suitable sanitary vessel.

The fitting may be adapted to be removed from the outlet of a sink, bath, shower or any suitable sanitary vessel.

The duckbill membrane sidewall or sidewalls may define an internal surface extending parallel to, or diverging from, a membrane longitudinal axis. Having the sidewall or sidewalls extending parallel to, or diverging from, the fitting longitudinal axis allows close contact be maintained between the duckbill membrane and formations.

The duckbill membrane sidewall or sidewalls may extend from the duckbill membrane inlet at a complementary angle to the/each fitting formation.

According to a second aspect of the invention there is provided a fitting for a one-way drain valve, the fitting comprising:

a body, the body defining a throughbore having a fitting longitudinal axis, the fitting further defining at least one formation, the/each formation having an internal surface, the/each internal surface defining a flat or a curved surface extending parallel to, or diverging from, the fitting longitudinal axis

wherein the fitting is adapted to be attached to a duckbill membrane such that, in use, the/each formation extends into the duckbill membrane, in contact with a membrane sidewall, permitting substantially unrestricted flow through the duckbill membrane.

In at least one embodiment of the present invention, in use, providing a one-way drain valve in which formations extend into a duckbill membrane, permits substantially unrestricted flow to be achieved through the one-way drain valve. This permits a greater flow area for liquids and any solids entrained in the liquids to pass through the one-way valve.

In at least one embodiment of the present invention, having the/each formation in contact with and supporting the duckbill membrane, prevents inward folding of the duckbill membrane thereby preventing backflow in a situation in which a negative pressure differential exists across the one-way drain valve. By a negative pressure differential it is meant that the upstream pressure is lower than the downstream pressure.

Embodiments of the second aspect of the invention may comprise one or more features of the first aspect of the invention or its embodiments, or vice versa.

According to a third aspect of the present invention, there is provided a duckbill membrane for a one-way drain valve, wherein the duckbill membrane is adapted to be attached to a fitting, the fitting comprising a body, the body defining a throughbore having a fitting longitudinal axis, the fitting further defining at least one formation, the/each formation having an internal surface, the/each internal surface defining a flat or a curved surface extending parallel to, or diverging from, the fitting longitudinal axis such that, in use, the/each formation extends into the duckbill membrane, in contact with a membrane sidewall, permitting substantially unrestricted flow through the duckbill membrane.

Embodiments of the third aspect of the invention may comprise one or more features of the first or second aspects of the invention or its embodiments, or vice versa.

### BRIEF DESCRIPTION OF THE DRAWINGS

Embodiments of the present invention will now be described, by way of example only, with reference to the accompanying drawings, in which:

FIG. 1 and FIG. 2 show a side and a front view respectively of a one-way valve 10 according to a first embodiment of the present invention.

FIG. 3 and FIG. 4 show a top and front view respectively of a second embodiment of the present invention.

FIG. 5 and FIG. 6 show a top and front view respectively of a third embodiment of the present invention.

### DETAILED DESCRIPTION OF THE DRAWINGS

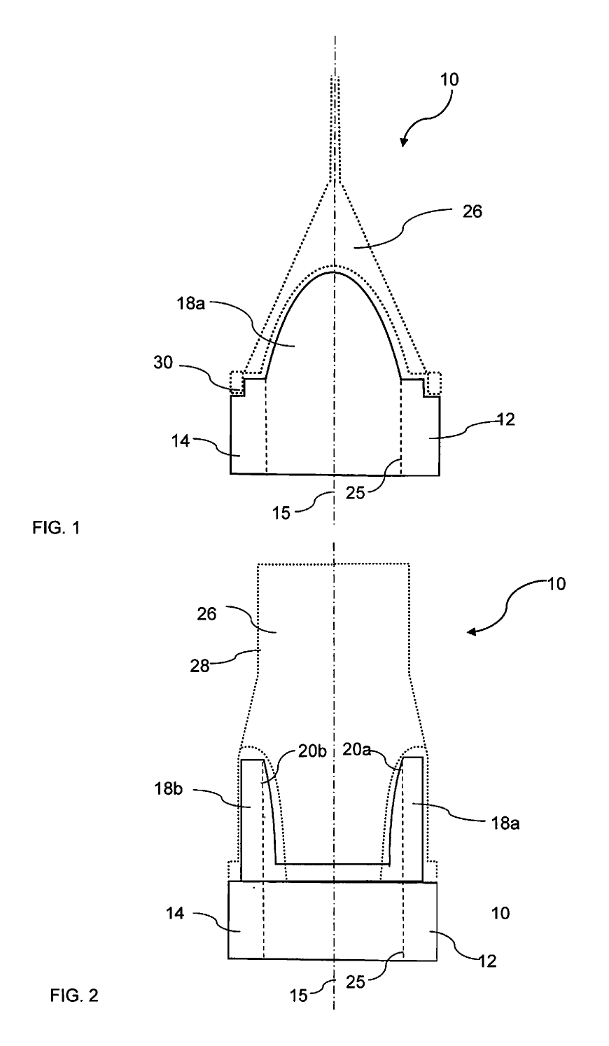

Referring to FIG. 1 and FIG. 2 an embodiment of the present invention corresponding to a first aspect of the invention will be described.

FIG. 1 and FIG. 2 show side and front views respectively of a one-way drain valve, generally indicated by reference numeral 10, according to a first embodiment of the present invention. The one-way drain valve 10 comprises a fitting 12. The fitting 12 comprises a body 14. The body 14 defines a throughbore 16 that has a longitudinal axis 15.The fitting 12 comprises a first formation 18a and a second formation 18b. The first and second formations 18a, 18b define a first internal surface 20a and a second internal surface 20b respectively. Each internal surface 20a, 20b defines a respective curved surface that extend parallel to a fitting longitudinal axis 15. The one-way drain valve 10 also comprises a duckbill membrane 26.The duckbill membrane 26 is attached to the fitting 12 such that each formation 18a, 18b extends into the duckbill membrane 26, in contact with a membrane sidewall 28 and the formations internal surfaces 20a, 20 bare at an equal distance from the fitting longitudinal axis 15 as the internal surface 25 of the fitting body 14.

The fitting 12 is made of polypropylene by injection moulding. The duckbill membrane 26 is made of silicone, also by injection moulding.

The fitting 12 has an internal diameter of 30 mm and a wall thickness of 1.5 mm. The fitting body 14 is 150 mm long. The formations 18a, 18b are 25 mm long, 1.5 mm thick and 15 mm wide at their base. The fitting body 14 comprises a recess 30. The recess 30 is 5 mm wide and 0.5 mm deep.

The duckbill membrane 26 has an internal diameter of 30 mm at its open end and is 50 mm long. The duckbill membrane sidewall 28 is 0.8 mm thick. The duckbill membrane sidewall 28 defines an internal surface that extends parallel to a fitting longitudinal axis.

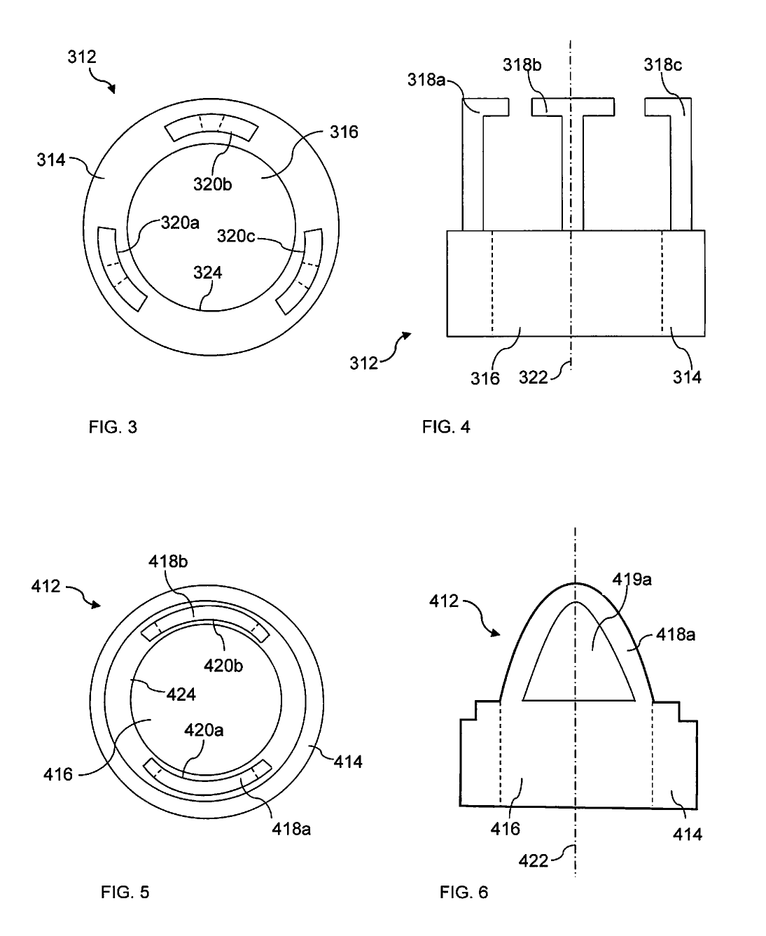

FIG. 3 and FIG. 4 show top and front views respectively of a fitting 312 for a one-way drain valve (not shown) according to a second embodiment of the present invention. The fitting 312 comprises a body 314. The body 314 defines a throughbore 316 that has a fitting longitudinal axis 322. The fitting 312 comprises three formations 318a, 318b, 318c, each having a T-shape with a curved cross bar. Each formation 318a, 318b, 318c defines a respective internal surface 320a, 320b, 320c. Each internal surface 320a, 320b, 320c defines a curved surface respectively that extends parallel to a fitting longitudinal axis 322 and is at a greater distance from the fitting longitudinal axis 322 than the internal surface 324 of the fitting body 314.

The fitting 312 has an internal diameter of 30 mm and a wall thickness of 1.5 mm. The fitting body 314 is 10 mm long. The formations 318 are 25 mm long, 1.5 mm thick, 3 mm wide at their base and the T cross bar is 10 mm wide.

FIG. 5 and FIG. 6 show top and front views of a fitting 412 for a one-way drain valve(not shown)according to a third embodiment of the present invention will be described. The fitting 412 comprises a body 414. The body 414 defines a throughbore 416 that has a fitting longitudinal axis 422. The fitting 412 comprises a first formation 418a and a second formation 418b, each having a parabolic shape. Each formation defines a recess respectively 419a, 419b. Each formation 418a, 418b respectively defines a respective internal surface 420a, 420b. Each internal surface 420a, 420b defines a respective curved surface that extends parallel to a fitting longitudinal axis 422 and is at a greater distance from the fitting longitudinal axis 422 than the internal surface 424 of the fitting body.

The fitting 412 is made of polypropylene by injection moulding. The fitting 412 has an internal diameter of 30 mm and a wall thickness of 1.5 mm. The fitting body 414 is 10 mm long. The formations 418 are 25 mm long, 1.5 mm thick and 3 mm wide at their base.

Various modifications and improvements may be made to the above-described embodiments without departing from the scope of the present invention for example, the foregoing embodiments are all of tubular shape but equivalent embodiments of a squared cross-section or other cross-sectional shapes may also be used.

1. A one-way drain valve, the one-way drain valve comprising:
a fitting, the fitting comprising a fitting body, the fitting body defining a throughbore having a fitting longitudinal axis, the fitting further defining at least one formation, the at least one formation having an internal surface, the internal surface defining a flat or a curved surface extending parallel to, or diverging from, the fitting longitudinal axis; and
a duckbill membrane,
wherein the duckbill membrane is attached to the fitting such that the at least one formation extends into the duckbill membrane, in contact with a duckbill membrane sidewall, permitting substantially unrestricted flow through the duckbill membrane.

2. A one-way drain valve according to claim 1 wherein the fitting comprises a plurality of formations.

3. A one-way drain valve according to claim 1 wherein the fitting comprises two formations.

4. A one-way drain valve according to claim 1 wherein the at least one formation extends into the duckbill membrane through a duckbill membrane inlet.

5. A one-way drain valve according to claim 1 wherein the at least one formation defines one or more recesses.

6. A one-way drain valve according to claim 1 wherein the fitting comprises a polymeric material.

7. A one-way drain valve according to claim 6 wherein the polymeric material is plastic.

8. A one-way drain valve according to claim 1 wherein the fitting comprises a cylindrical body.

9. A one-way drain valve according to claim 1 wherein the fitting body defines a cylindrical internal surface.

10. (canceled)

11. A one-way drain valve according to claim 9 wherein the internal surface extends parallel to the fitting longitudinal axis.

12. A one-way drain valve according to claim 9 wherein the internal surface is equidistant from the fitting longitudinal axis as the internal surface of the at least one formation.

13. A one-way drain valve according to claim 9 wherein the internal surface is spaced away from the fitting longitudinal axis by a distance greater than or less than the internal surface of the at least one formation.

14. A one-way drain valve according to claim 1 wherein the at least one formation extends into the duckbill membrane through a duckbill membrane inlet, wherein the duckbill membrane inlet has an inlet diameter, and wherein the fitting body has a diameter equal to the inlet diameter of the duckbill membrane.

15. A one-way drain valve according to claim 1 wherein the fitting body comprises a recess to receive the duckbill membrane.

16. A one-way drain valve according to claim 1 wherein the fitting is adapted to be inserted into the outlet of a sink, bath, shower or any other sanitary vessel.

17. A one-way drain valve according to claim 1 wherein the fitting is adapted to be removed from the outlet of a sink, bath, shower or any other sanitary vessel.

18. A one-way drain valve according to claim 1 wherein the duckbill membrane sidewall define an internal surface extending parallel to, or diverging from, a membrane longitudinal axis.

19. A one-way drain valve according to claim 1 wherein the at least one formation extends into the duckbill membrane through a duckbill membrane inlet, wherein the duckbill membrane inlet has an inlet diameter, and wherein the duckbill membrane sidewall extend from the duckbill membrane inlet at a complementary angle to the at least one formation.

20. A fitting for a one-way drain valve, the fitting comprising:
a body, the body defining a throughbore having a fitting longitudinal axis, the fitting further defining at least one formation, the at least one formation having an internal surface, the internal surface defining a flat or a curved surface extending parallel to, or diverging from, the fitting longitudinal axis,
wherein the fitting is adapted to be attached to a duckbill membrane such that, in use, the at least one formation extends into the duckbill membrane, in contact with a membrane sidewall, permitting substantially unrestricted one-way flow through the duckbill membrane.

21. A duckbill membrane for a one-way drain valve, wherein the duckbill membrane is adapted to be attached to a fitting, the fitting comprising a body, the body defining a throughbore having a fitting longitudinal axis, the fitting further defining at least one formation, the at least one formation having an internal surface, internal surface defining a flat or a curved surface extending parallel to, or diverging from, the fitting longitudinal axis such that, in use, the at least one formation extends into the duckbill membrane, in contact with a membrane sidewall, permitting substantially unrestricted one-way flow through the duckbill membrane.
